(19) United States
(12) Patent Application Publication
(10) Pub. No.: US 2023/0233971 A1
(43) Pub. Date: Jul. 27, 2023

(54) AIR FILTER AND AIR PURIFIER COMPRISING SAME

(71) Applicant: COWAY CO., LTD., Gongju-si (KR)

(72) Inventors: Yoon Hyuck CHOI, Seoul (KR); Sung Il MOON, Seoul (KR); Jun Houng BAE, Seoul (KR); Yu Young NAM, Seoul (KR); Sun Duck KWON, Seoul (KR); Ju Hyun BAEK, Seoul (KR); Chan Jung PARK, Seoul (KR)

(73) Assignee: COWAY CO., LTD., Gongju-si (KR)

(21) Appl. No.: 18/002,612

(22) PCT Filed: Jun. 21, 2021
(86) PCT No.: PCT/KR2021/007752

§ 371 Date: Dec. 20, 2022

(30) Foreign Application Priority Data
Jun. 22, 2020 (KR) 10-2020-0075789

(51) Int. Cl. B01D 46/00; B01D 46/60; B01D 46/52; F24F 8/108; F24F 8/158

(52) U.S. Cl. CPC B01D 46/0016; B01D 46/0005; B01D 46/0013; B01D 46/60; B01D 46/523; B01D 46/0036; F24F 8/108; F24F 8/158; B01D 2265/05; B01D 2265/06; B01D 2267/30; B01D 2267/70; B01D 2271/022; B01D 2271/027; B01D 2277/30; B01D 2279/50

(57) ABSTRACT

An air purifier has an air filter including: a filter member including a plurality of filtration regions each having a plurality of vertical pleats extending in an up-down direction and side surfaces connected to be rotatable with respect to each other; and a frame having a plurality of supports for supporting the plurality of filtration regions. Each of the plurality of supports includes a groove having a shape corresponding to any one of an upper edge and a lower edge of each of the filtration regions. Each of the filtration regions is supported by the supports by at least a part of the upper edge or the lower edge being inserted into the groove.

### TECHNICAL FIELD

The present disclosure relates to an air filter and air purifier including same.

### BACKGROUND ART

In general, an air purifier is a device for sucking polluted indoor air, and filtering out dust, odor particles, and the like contained in the air through a filter to purify the air into clean air. Such an air purifier may purify indoor air by sucking in and purifying the surrounding polluted air, and then discharging the purified clean air to the outside of the air purifier.

Meanwhile, the air purifier may include a filter for filtering out dust, odor particles, and the like contained in the air introduced into the air purifier. Such a filter may have various shapes depending on the type of the air purifier. For example, the filter may be provided in a cylindrical shape, a rectangular parallelepiped shape, or the like.

However, the filter having the above-described shape occupies a relatively large volume in the process of transporting, which incurs a high cost for transporting the filter. In addition, in recent years, the demand for a filter having a large area is increasing in order to purify air in a large space, and the volume occupied by the filter during transportation is increasing. Accordingly, filters having a reduced volume upon transportation of the filters have been developed.

U.S. Patent Application Publication No. 2018/0221805 “Air Purifier” of the present applicant and U.S. Patent Application Publication No. 2018/0304184 “Foldable Air Filter Unit” of Blueair AB disclose a foldable filter capable of reducing the volume upon transportation of the filter. However, according to the conventional folding filter, since a complicated hinge structure is required for, folding, and the structure and manufacturing process of the foldable filter are complicated by using a complicated structure or a separate adhesive to combine the filter and a support (frame), there is a problem in that the manufacturing cost of the foldable filter increases.

In particular, the foldable filter is not repeatedly unfolded and folded, but after the folded state is maintained until the filter reaches the user, the unfolded state is maintained while the user uses the filter, so that it is not desirable to use an expensive hinge structure for only a few folding operations.

Accordingly, there is a need for a foldable filter with a simple structure capable of simplifying the manufacturing process and reducing manufacturing cost.

### Prior Art Document

(Patent Document 1) US Patent Application Publication No. 2018/0221805 (published on Aug. 9, 2018)

(Patent Document 2) US Patent Application Publication No. 2018/0304184 (Published on Oct. 25, 2018)

### DETAILED DESCRIPTION OF INVENTION

### Technical Problems

In view of the above, embodiments of the present disclosure provide an air filter which secures a large filtration area to filter a large amount of air and can reduce a volume thereof during transportation.

In addition, embodiments of the present disclosure provide an air filter which can be used for a long time by improving the durability of the foldable filter while simplifying the structure of the foldable filter.

Further, embodiments of the present disclosure provide an air filter capable of reducing the time and cost required for manufacturing the filter by simplifying the structure of the filter.

### Technical Solution

In accordance with one aspec of the present disclosure, there may be provided an air filter including: a filter member including a plurality of filtration regions each having a plurality of vertical pleats extending in an up-down direction and side surfaces connected to be rotatable with respect to each other; and a frame having a plurality of supports for supporting the plurality of filtration regions, wherein each of the plurality of supports includes a groove having a shape corresponding to any one of an upper edge and a lower edge of each of the filtration regions, and wherein each of the filtration regions is supported by the supports by at least a part of the upper edge or the lower edge being inserted into the groove.

Further, the plurality of filtration regions may include three or more filtration regions, and when each of the plurality of filtration regions is rotated with respect to the adjacent filtration region adjacent at an angle smaller than a straight angle, the plurality of filtration regions are arranged along a loop-shaped path.

Further, the plurality of filtration regions may be provided in an even number.

Further, the plurality of filtration regions may be rotatable with respect to each other so that at least two filtration regions adjacent to each other are arranged in parallel.

Further, the plurality of filtration regions may be integrally connected to each other.

Further, the air filter may further include a bracket fixed to side surfaces of different filtration regions to reinforce portions in which the plurality of filtration regions are connected.

Further, ends of the plurality of supports may be integrally connected to each other so that the plurality of supports are rotatable with respect to each other.

Further, the plurality of support parts may be formed of an elastic material which is moldable.

Further, each of the plurality of supports may further include a recess for molding, and the groove and the recess for molding are formed on opposite surfaces of the corresponding support.

Further, the recess for molding may extend in a direction crossing the upper edge or the lower edge.

Further, the air filter may further include a plurality of filtration modules for filtering outside air, and the plurality of filtration modules may be are arranged in parallel with the plurality of filtration regions and supported by the plurality of supports, respectively.

Further, each of the plurality of filtration modules may include an activated carbon deodorization filter.

Further, there may be provided an air purifier including: an air; and a blower for providing blowing force to allow outside air to pass through the air filter.

### Effect of Invention

According to embodiments of the present disclosure, when transporting the filter which secures a large filtration area to filter a large amount of air, the volume of the filter can be reduced.

In addition, the cost of transporting the filter can be reduced by reducing the volume of the filter.

Further, the air filter can be used for a long time by improving the durability of the filter while simplifying the structure of the foldable filter.

Furthermore, the time and cost required for manufacturing the filter can be reduced by simplifying the process of manufacturing the filter.

### BRIEF DESCRIPTION OF THE DRAWINGS

FIG. 1 is a perspective view showing an air purifier according to a first embodiment of the present disclosure.

FIG. 2 is a cross-sectional view taken along II-II of FIG. 1.

FIG. 3 is a perspective view of the air filter shown in FIG. 2.

FIG. 4 is a partial perspective view of the air filter in FIG. 3.

FIG. 5 is an exploded perspective view of the air filter in FIG. 3.

FIG. 6 is a perspective view of a filter member and a frame in FIG. 3.

FIG. 7 is a perspective view of the air filter in FIG. 3 in a folded state.

FIG. 8 is a perspective view of an air filter according to a second embodiment of the present disclosure.

### BEST MODE FOR CARRYING OUT THE INVENTION

Hereinafter, a preferred embodiment of the present disclosure for implementing the spirit of the present disclosure will be described in more detail with reference to the accompanying drawings.

However, in describing the present disclosure, detailed descriptions of known configurations or functions may be omitted to clarify the present disclosure.

When an element is referred to as being ‘connected’ to, ‘supported’ by, or ‘flowed’ into another element, it should be understood that the element may be directly connected to, supported by, or flowed into the other element, but that other elements may exist in the middle.

The terms used in the present disclosure are only used for describing specific embodiments, and are not intended to limit the present disclosure. Singular expressions include plural expressions unless the context clearly indicates otherwise.

Terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements and/or combinations thereof disclosed in the specification, and are not intended to preclude the possibility that one or more other certain features, areas, integers, steps, actions, elements and/or combinations thereof may exist or may be added.

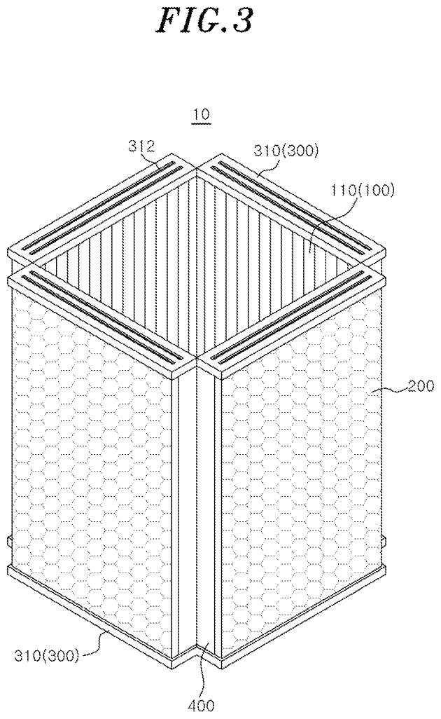

Furthermore, in the present disclosure, it is to be noted that expressions, such as the upper side and the lower side, are described based on the illustration of drawings, but may be modified if directions of corresponding objects are changed. Meanwhile, in the present specification, an up and down direction may be based on the up and down direction of FIGS. 3 to 6.

Hereinafter, a specific configuration of the air purifier 1 according to a first embodiment of the present disclosure will be described with reference to the drawings.

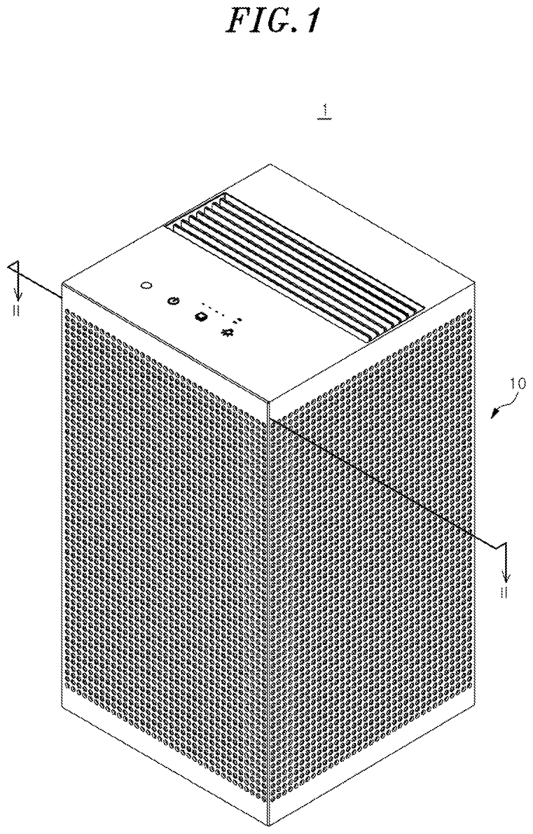

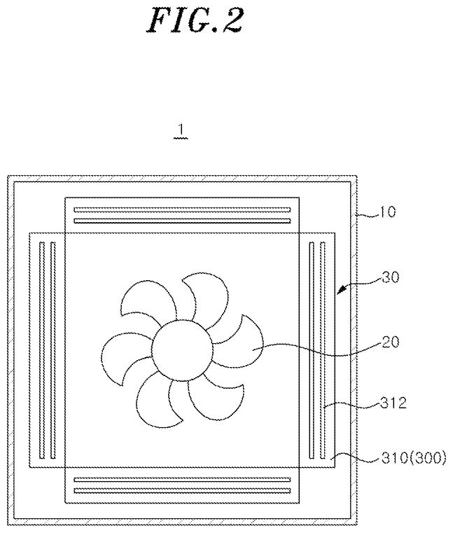

Hereinafter, referring to FIGS. 1 and 2, the air purifier 1 according to the first embodiment of the present disclosure can purify polluted air into clean air by filtering out dust odor particles, and the like in the air introduced into the air purifier 1. In addition, the air purifier 1 can suck air outside the air purifier into, the inside thereof and discharge clean air purified from the inside to the outside The air purifier 1 may include a body 10, a blower 20, and an air filter 30.

The body 10 may support the blower 20 and the air filter 30, and provide a space in which the blower 20 and the air filter 30 are accommodated. The body 10 may include a case surrounding the blower 20 sand the air filter 30.

The blower 20 may be driven to allow polluted air outside the air purifier 1 to be introduced into the inside of the air purifier 1. The blower 20 may provide blowing force for causing the introduced air to pass through the air filter 30. In addition, the blower 20 may be driven to discharge the clean air inside the air purifier 1 to the outside. For example, the blower 20 may be disposed at a lower side in the body 10, and may be disposed inside the air filter 30.

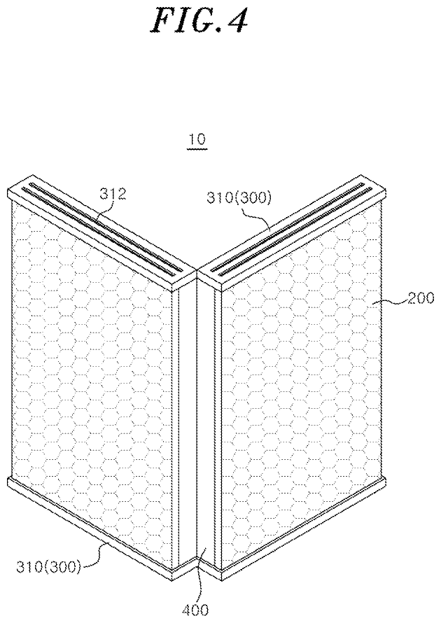

Referring to FIGS. 3 and 4, the air filter 30 may filter the air introduced from the outside of the air purifier 1 into clean air. For example, it is possible to filter out dust, odor particles, and the like in the air. In addition, the air filter 30 may be provided to be selectively foldable. For example, the air filter 30 may be folded to minimize the volume of the air filter 30 during delivery, and may be unfolded to perform the function of the air filter 30 after delivery. The air filter 30 may include a filter member 100, a filtration module 200, a frame 300, and a bracket 400.

The filter member 100 is configured to allow air to pass therethrough, and can filter the air passing through the filter member 100 into clean air. The filter member 100 may be formed to extend in an up-down direction, and upper and, lower sides of the filter member 100 may be supported by the frame 300. In addition, one surface of the filter member 100 through which air passes may be arranged in parallel with one surface of the filtration module 200. For example, the filter member 100 may secondarily filter the air that has been primarily filtered through the filtration module 200. The filter member 100 may include a plurality of filtration regions 110.

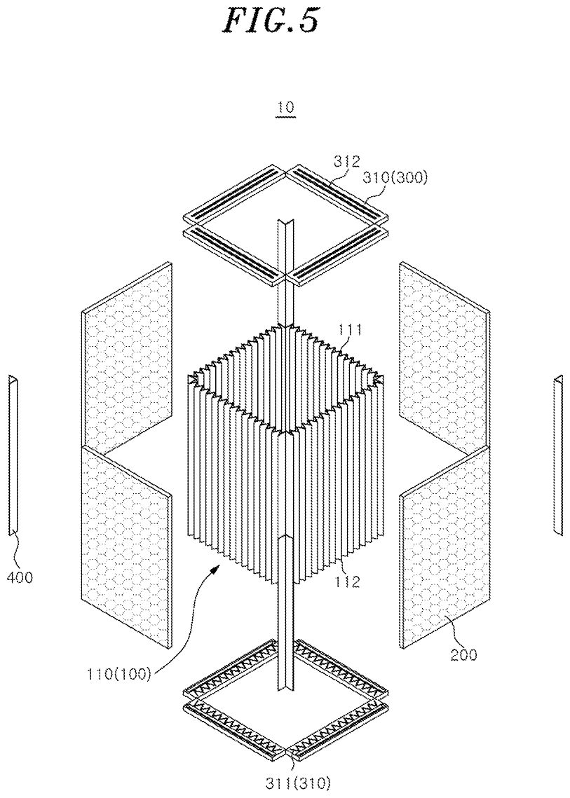

Referring to FIG. 5, the filtration region 110 may be provided to filter air. A plurality of pleats extending in the up-down direction may be formed in the filtration region 110. For example, the plurality of pleats of the filtration region 110 may be folded to be contracted in a direction perpendicular to the up-down direction or may be unfolded to be stretched in the direction perpendicular to the up-down direction. In addition, a first edge 111 and a second edge 112 may be formed at upper and lower sides of the filtration region 110, and a plurality of pleats may be formed to extend between the first edge 111 and the second edge 112.

The first edge 111 may be formed at an upper edge of the filtration region 110. The first edge 111 may be inserted into a groove 311 to be described later, and may be supported by a support 310 to be described later.

The second edge 112 may be formed at a lower edge of the filtration region 110. The second edge 112 may be inserted into the groove 311 and may be supported by the support 310.

Meanwhile, in the present specification, it is described that the first edge 111 is formed at the upper side of the filtration region 110 and the second edge 112 is formed at the lower side of the filtration region 110, but this is only an example and it is also possible that the first edge 111 is formed at the lower side of the filtration region 110 and the second edge 112 is formed at the upper side of the filtration region 110.

Meanwhile, the filtration regions 110 may include a plurality of filtration regions 110. For example, an even number of filtration regions 110 may be provided. Hereinafter, it is described that four filtration regions 110 are provided, but this is only an example and may be provided in any number. The plurality of filtration regions 110 may be integrally formed, and side surfaces thereof may be connected to be rotatable with respect to each other. In other words, any one of the plurality of filtration regions 110 may rotate with respect to another adjacent filtration region 110. For example, each of the plurality of filtration regions 110 may be configured to be folded with respect to the adjacent filtration region 110 in a manner of rotating about an imaginary axis extending in the up-down direction.

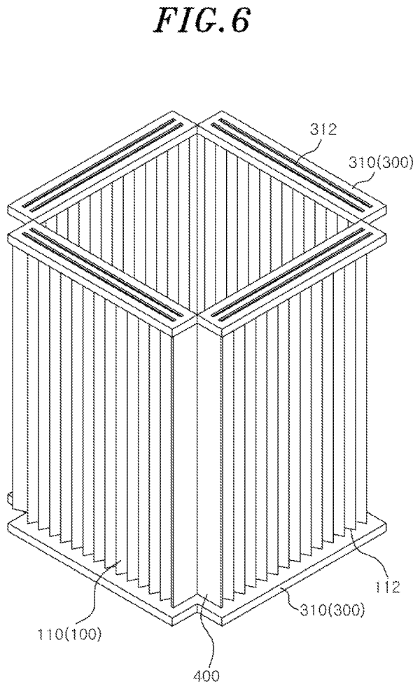

Referring to FIG. 6, when each of the plurality of filtration regions 110 is rotated with respect to each other to form an angle smaller than a straight angle with the adjacent filtration region 110, the plurality of filtration regions 110 may be arranged to form a loop-shaped path. In this case, the loop-shaped path may be defined as a path which starts from one point, passes through another point and returns to the one point back. As a detailed example, the plurality of filtration regions 110 may be rotated with respect to each other to form a predetermined angle (90° in case of four filtration regions) with the adjacent filtration region 110. In this case, the predetermined angle may be an angle at which, the area of the inner space surrounded by the plurality of filtration regions 110 is maximized when viewed from above. At this time, as shown in FIG. 2, the plurality of filtration regions 110 viewed from above may form a rectangular loop. As such, when each of the plurality of filtration regions 110 forms an angle greater than 0° and less than 180° with the adjacent filtration region 110 t is defined as an unfolded state.

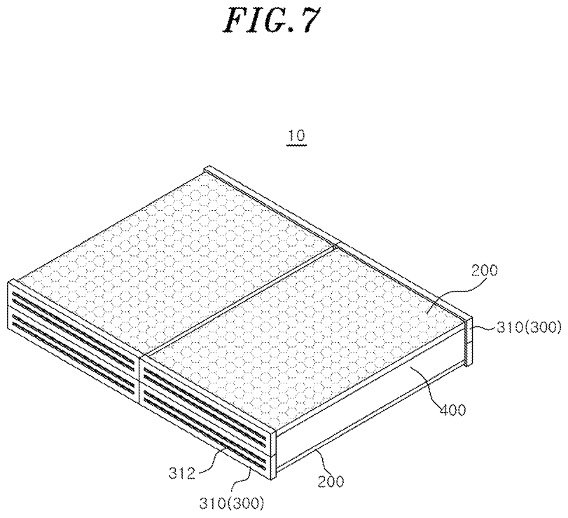

Referring to FIG. 7, the plurality of filtration regions 110 may rotate with respect to each other so that at least two filtration regions 110 adjacent to each other are arranged in parallel. As a detailed example, any one filtration region 110 among the plurality of filtration regions 110 may be folded with respect to another filtration region 110 connected to one side thereof by rotating with respect to the another filtration region 110. In this case, an angle between one filtration region 110 and another filtration region 110 connected to the one side of the one filtration region 110 is 0°. In addition, the one filtration region 110 may be unfolded with respect to further another filtration region 110 connected to the other side thereof by rotating with respect to the further another filtration region 110. When the angle between each of the plurality of filtration regions 110 and the filtration region 110 adjacent thereto is 0° or 180°, it is defined as a folded state. In this case, an angle between the one filtration region 110 and the further another filtration region 110 connected to the other side thereof is 180°.

As described above, when the plurality of filtration regions 110 are in the folded state, two filtration regions 110 adjacent to each other are arranged in parallel, so that the adjacent filtration regions 110 can be in close contact with each other. In addition, since the space between the plurality of filtration regions 110 is minimized, the volume of the filter member 100 is minimized.

The filtration module 200 may be provided to filter the air introduced from the outside. For example, the filtration module 200 may include an activated carbon deodorization filter (carbon filter). The filtration module 200 may include a plurality of filtration modules, and the plurality of filtration modules 200 may be supported by a plurality of supports 310. For example, upper and lower sides of the filtration module 200 may be supported by the support 310. In addition, each of the plurality of filtration modules 200 may be fixed to the plurality of supports 310 through molding.

Further, the filtration module 200 may be disposed in parallel with the filtration region 110, and may be disposed outside the filtration region 110. In other words, the filtration module 200 may be disposed to surround at least a portion of the filtration region 110. Accordingly, the filtration module 200 may primarily filter the air introduced from the outside before being filtered through the filtration region 110.

The frame 300 may support the filter member 100 and the filtration module 200. The frame 300 may include the support 310 for supporting the filtration region 110 and the filtering module 200.

The support 310 may support the filtration region 110 and the filtration module 200 at the upper and lower sides. The support 310 may support the filtration region 110 and the filtration module 200 through molding, and the support 310 may be formed of an elastic material that can be molded. For example, the support 310 may include a material having elasticity, such as urethane, rubber, or the like.

In addition the support 310 may include a plurality of supports to support the plurality of filtration regions 110 and the plurality of filtration modules 200. The plurality of supports 310 may be integrally formed with each other, and end portions thereof may be connected to be rotatable with respect to each other. In other words, any one of the plurality of supports 310 may be folded with respect to another support 310 adjacent thereto. Further, the plurality of supports 310 may rotate in response to rotation of the plurality of filtration regions 110. Some of the plurality of supports 310 may fixedly support the plurality of filtration regions 110 and the plurality of filtration modules 200 at the upper side, and the remaining of the plurality of supports 310 may fixedly support the plurality of filtration regions 110 and the plurality of filtration modules 200 at the lower side.

Meanwhile, a groove 311 and a recess 312 for molding may be formed in the, support 310.

The filtration region 110 is inserted, in the groove 311 of the support 310. The groove 311 may be formed to be depressed in a predetermined depth from the surface of the support 310, and may be formed in each of the plurality of supports 310. For example, when the support 310 and the filtration region 110 are molded, the groove 311 may be a portion formed by the filtration region 110 inserted into the support 310. As such, a portion of the filtration region 110 is inserted and engaged into the groove 311, so that the filtration region 110 may be stably fixed by the support 310. In addition, the first edge 111 may be inserted into some of the plurality of supports 310 disposed on the upper side, and the second edge 112 may be inserted into the remaining of the plurality of supports 310 disposed on the lower side. The groove 311 may have a shape corresponding to the shape of the first edge 111 or the second edge 112. In the present specification, the groove 311 may be a concept including not only a groove formed in a concave shape in a plane, but also a space formed between a plurality of protrusions.

The recess 312 for molding may be formed in each, of the plurality of supports 310 in order to prevent the filtration region 110 from penetrating the supports 310. For example, the recess 312 for molding may be a portion in which a stopper mold (not shown) is inserted in order to prevent the filtration region 110 from penetrating the support 310 by a predetermined depth or more when the support 310 and the filtration region 110 are molded. In this case, the stopper mold may be inserted in a side of the support 310 opposite to the side in which the filtration region 110 is inserted. Accordingly, the recess 312 for molding formed by the stopper mold may be formed on a surface opposite to the groove 311. As a detailed example, the sum of a depth of the recess 312 for molding and a depth, of the groove 311 may be equal to or smaller than a thickness of the support 310. Further, the recess 312 for molding may extend in a direction crossing the first edge 111 or the second edge 112. For example, the recess 312 for molding may extend along a direction in which the support 310 extends.

The bracket 400 may be provided to reinforce between the adjacent filtration regions 110 among the plurality of filtration regions 110. Both end portions of the bracket 400 may be respectively fixed to two filtration regions 110 adjacent to each other among the plurality of filtration regions 110. For example, the bracket 400 may be fixed to the filtration region 110 through an adhesive layer (not shown). In addition, the bracket 400 may includes a plurality of brackets, and the plurality of brackets 400 may improve durability between the plurality of filtration regions 110.

Meanwhile, the bracket 400 may be configured to be folded or unfolded in response to the rotation of the filtration region 110. For example, when the filtration region 110 is in the unfolded state (that is, when the air filter 30 is in a first state in which the air filter 30 is mounted in the air purifier 1), the bracket 400 may form an angle larger than 0° and smaller than 180°. In addition, when the filtration region 110 is in the folded state (that is, when the air filter 30 is in a second state in which the air filter 30 is removed from the air purifier 1 to be stored or transported), the bracket 400 disposed between some of the plurality of filtration regions 110 may be fully unfolded to form an angle of 180°, and the bracket 400 disposed between other some of the plurality of filtration regions 110 may be folded to form an angle of 0°. The bracket 400 may be made of a flexible material including at least one of a porous material such as a foam, a nonwoven fabric, a synthetic fiber, and a natural fiber, for example. As such, the bracket 400 may be configured to be folded or unfolded, thereby reinforcing between the adjacent filtration regions 110.

Hereinafter, the effect of the air purifier 1 having the above described configuration will be described.

The air filter 30 can be easily converted into the unfolded state or the folded state since the plurality of filtration regions 110 are configured to be rotatable with respect to each other.

In addition, when the air filter 30 is in the folded state, the adjacent filtration regions 110 are arranged to be in contact with each other, so that the space between the plurality of filtration regions 110 can be minimized. When the air filter 30 is in the folded state, the volume thereof can be minimized, thereby reducing the cost required for transportation. Further, the air filter 30 can be converted to the unfolded state after transportation to perform a filter function.

Meanwhile, the bracket 400 may be attached to a portion where one filtration region 110 is connected to another filtration region 110, which reinforces the connection portion and improves durability.

In addition, the support 310 can more stably support the filtration region 110 and the filtering module 200 through molding. Such a support 310 can improve the durability of the filtration region 110 by rotating in response to the rotation of the filtration region 110. Further, by simplifying the structure and process between the filtration region 110 and the support 310 through molding, the time and cost required for the process can be reduced.

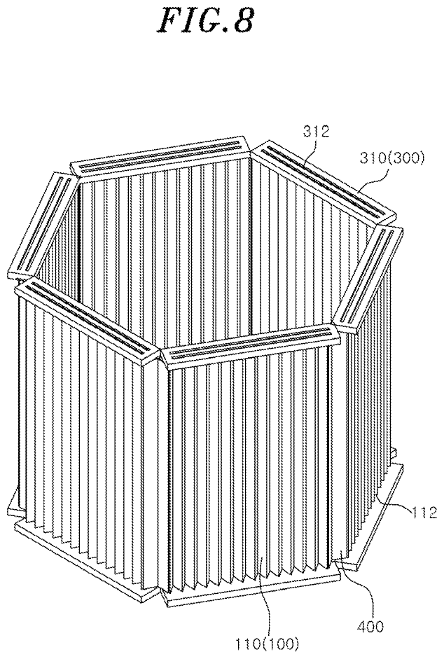

Meanwhile, in addition to the above configuration, according to a second embodiment of the present disclosure, six filtration regions 110 and six supports 310 may be provided. Hereinafter, the second embodiment of the present disclosure will be described with further reference to FIG. 8 The description of the second embodiment description will be made mainly on the difference compared with the above described embodiment and the same descriptions and reference numerals are referred to the above described embodiment.

Six filtration regions 110 and six supports 310 may be provided. Each of the plurality of filtration regions 110 may rotate with respect to each other to form an angle of 120° with the adjacent filtration region 110 when in the unfolded state. In addition, the plurality of filtration regions 110 viewed from above may form a hexagonal loop. Each of the plurality of supports 310 may rotate in response to the rotation of the plurality of filtration regions 110.

Such filtration regions 110 can filter the air introduced from more various directions, and can improve the filtration efficiency.

The examples of the present disclosure have been described above as specific embodiments, but these are only examples, and the present disclosure is not limited thereto, and should be construed as having the widest scope according to the technical spirit disclosed in the present specification. A person skilled in the art may combine/substitute the disclosed embodiments to implement a pattern of a shape that is not disclosed, but it also does not depart from the scope of the present disclosure. In addition, those skilled in the art can easily change or modify the disclosed embodiments based on the present specification, and it is clear that such changes or modifications also belong to the scope of the present disclosure.

1. An air filter comprising:
a filter member including a plurality of filtration regions each having a plurality of vertical pleats extending in an up-down direction and side surfaces connected to be rotatable with respect to each other; and
a frame having a plurality of supports for supporting the plurality of filtration regions,
wherein each of the plurality of supports includes a groove having a shape corresponding to any one of an upper edge and a lower edge of each of the filtration regions, and
wherein each of the filtration regions is supported by the supports by at least a part of the upper edge or the lower edge being inserted into the groove.

2. The air filter of claim 1, wherein the plurality of filtration regions include three or more filtration regions, and when each of the plurality of filtration regions is rotated with respect to the adjacent filtration region adjacent at an angle smaller than a straight angle, the plurality of filtration regions are arranged along a loop-shaped path.

3. The air filter of claim 2, wherein the plurality of filtration regions are provided in an even number.

4. The air filter of claim 1, wherein the plurality of filtration regions are rotatable with respect to each other so that at least two filtration regions adjacent to each other are arranged in parallel.

5. The air filter of claim 1, wherein the plurality of filtration regions are integrally connected to each other.

6. The air filter of claim 1, further comprising:
a bracket fixed to side surfaces of different filtration regions to reinforce portions in which the plurality of filtration regions are connected.

7. The air filter of claim 1, wherein ends of the plurality of supports are integrally connected to each other so that the plurality of supports are rotatable with respect to each other.

8. The air filter of claim 1, wherein the plurality of support parts are formed of an elastic material which is moldable.

9. The air filter of claim 1, wherein each of the plurality of supports further includes a recess for molding, and the groove and the recess for molding are formed on opposite surfaces of the corresponding support.

10. The air filter of claim 9, wherein the recess for molding extends in a direction crossing the upper edge or the lower edge.

11. The air filter of claim 1, further comprising:
a plurality of filtration modules for filtering outside air,
wherein the plurality of filtration modules are arranged in parallel with the plurality of filtration regions and supported by the plurality of supports, respectively.

12. The air filter of claim 11, wherein each of the plurality of filtration modules includes an activated carbon deodorization filter.

13. An air purifier comprising:
the air filer of claim 1; and
a blower for providing blowing force to allow outside air to pass through the air filter.
